(19) United States
(12) Patent Application Publication
(10) Pub. No.: US 2014/0169004 A1
(43) Pub. Date: Jun. 19, 2014

(54) Lamp Device and Luminaire

(71) Applicants: Hiromichi Nakajima, Yokosuka-shi (JP); Shinichiro Matsumoto, Yokosuka-shi (JP); Masahiko Kamata, Yokosuka-shi (JP); Yuichiro Takahara, Yokosuka-shi (JP); Hiroshi Matsushita, Yokosuka-shi (JP); Shinichi Kumashiro, Yokosuka-shi (JP); Shigeru Osawa, Yokosuka-shi (JP)

(72) Inventors: Hiromichi Nakajima, Yokosuka-shi (JP); Shinichiro Matsumoto, Yokosuka-shi (JP); Masahiko Kamata, Yokosuka-shi (JP); Yuichiro Takahara, Yokosuka-shi (JP); Hiroshi Matsushita, Yokosuka-shi (JP); Shinichi Kumashiro, Yokosuka-shi (JP); Shigeru Osawa, Yokosuka-shi (JP)

(73) Assignee: TOSHIBA LIGHTING & TECHNOLOGY CORPORATION, Yokosuka-shi, Kanagawa-ken (JP)

(21) Appl. No.: 14/239,451

(22) PCT Filed: Sep. 27, 2011
(86) PCT No.: PCT/JP2011/072099

§ 371 Date: Feb. 18, 2014

(51) Int. Cl. F21V 29/00

(52) U.S. Cl. CPC F21V 29/004
USPC 362/373

(57) ABSTRACT

A lamp device includes a semiconductor light-emitting element. The lamp device includes a housing including a heat conductive part, and the heat conductive part is thermally connected to an external thermal radiator. Heat generated by the semiconductor light-emitting element is conducted to the thermal radiator through the heat conductive part. A thermosensor is thermally connected to the heat conductive part. The lamp device includes a lighting circuit to light the semiconductor light-emitting element, and the lighting circuit controls an output of the semiconductor light-emitting element according to detection of the thermosensor.

### TECHNICAL FIELD

Embodiments of the invention relate to a lamp device using a semiconductor light-emitting element as a light source and a luminaire using the lamp device.

### BACKGROUND ART

Hitherto, there is a luminaire in which a lamp device using, for example, a flat type cap of GX53-type or the like, and a lighting equipment including a socket on which the cap of the lamp device is detachably mounted are combined and used.

The lamp device includes a housing including a cap, an LED element arranged in the housing, and a lighting circuit to light the LED element. In the lamp device, at the time of lighting of the LED element, heat generated by the LED element is conducted from the housing to a thermal radiator of the lighting equipment and is radiated.

### CITATION LIST

### Patent Literature

PTL 1: Japanese Laid-open Patent Publication No. 2010-262781

### SUMMARY OF INVENTION

### Technical Problem

When a plurality of kinds of lamp devices is provided according to, for example, difference in light output, and a plurality of kinds of lighting equipments suitable for the respective kinds of lamp devices is provided, suitable kinds of lamp devices and lighting equipments are combined and used, so that specified performance as a luminaire can be obtained.

However, if unsuitable kinds of lamp devices and lighting equipments are combined and used, there is a disadvantage that the specified performance as the luminaire cannot be obtained. For example, if a lamp device having high output is mounted on a lighting equipment corresponding to a lamp device having low output, sufficient heat dissipation for the lamp device having high output cannot be obtained by the lighting equipment corresponding to the lamp device having low output, and there is a fear that abnormal thermal radiation of the lamp device occurs.

The problem to be solved by the invention is to provide a lamp device which detects abnormal thermal radiation at the time of lighting and can control lighting of a semiconductor light-emitting element, and a luminaire using the lamp device.

### Solution to Problem

A lamp device according to an embodiment includes a semiconductor light-emitting element. The lamp device includes a housing including a heat conductive part, and the heat conductive part is thermally connected to an external thermal radiator. Heat generated by the semiconductor light-emitting element is conducted to the thermal radiator through the heat conductive part. A thermosensor is thermally connected to the heat conductive part. The lamp device includes a lighting circuit to light the semiconductor light-emitting element, and the lighting circuit controls an output of the semiconductor light-emitting element according to detection of the thermosensor.

### BRIEF DESCRIPTION OF DRAWINGS

FIG. 1 A sectional view of a lamp device of a first embodiment.

FIG. 2 A front view of a lighting circuit of the lamp device.

FIG. 3 A sectional view of a luminaire in which the lamp device and a lighting equipment are combined.

FIG. 4 A circuit view of a part of the lighting circuit of the lamp device.

FIG. 5 A sectional view of a lamp device of a second embodiment.

### DESCRIPTION OF EMBODIMENTS

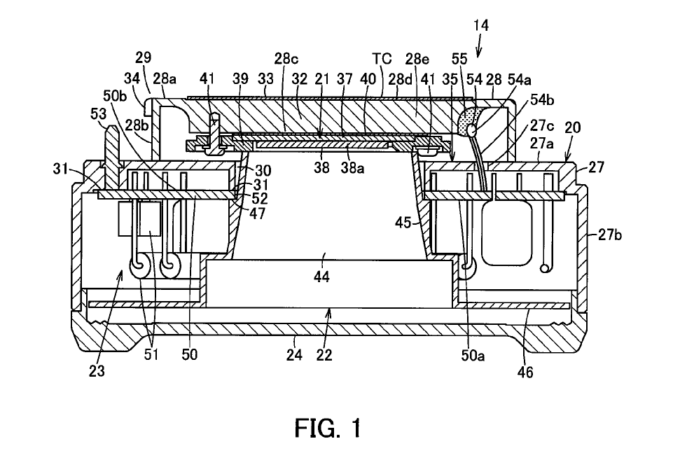

Hereinafter, a first embodiment will be described with reference to FIG. 1 to FIG. 4.

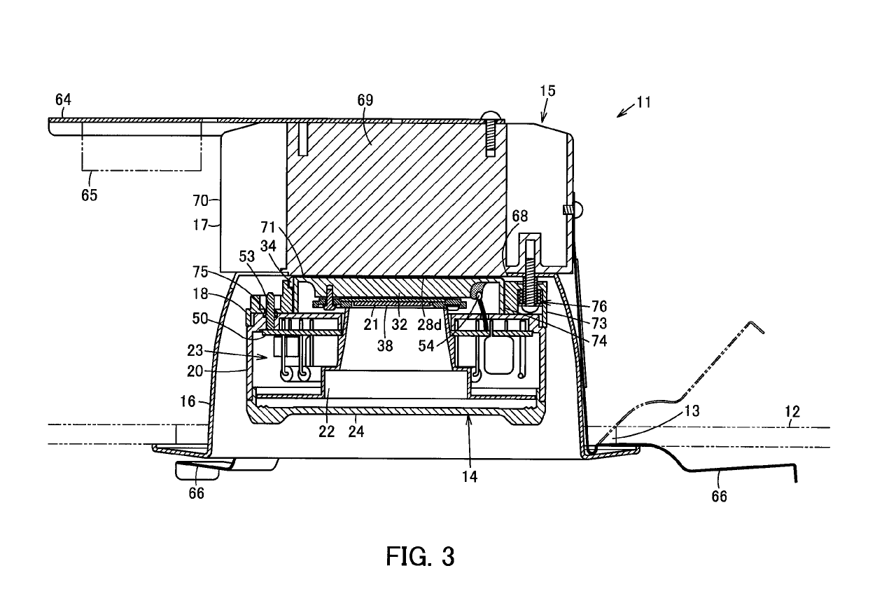

As shown in FIG. 3, a luminaire 11 is an embedded-type luminaire such as a downlight and is installed to be embedded in a circular embedding hole 13 provided in a ceiling plate 12. The luminaire 11 includes a flat lamp device 14 and a lighting equipment 15 which enables the lamp device 14 to be detachably attached.

The lighting equipment 15 includes a reflector 16 expanding and opening downward, a thermal radiator 17 attached to the upper part of the reflector 16, a socket 18 attached to the lower part of the thermal radiator 17, and the like.

As shown in FIG. 1, the lamp device 14 includes a flat and cylindrical housing 20. A light-emitting module 21, an optical component 22 and a lighting circuit 23 are arranged in the housing 20, and a translucent cover 24 is attached to a lower surface of the housing 20.

The housing 20 includes a cylindrical case 27, and a cylindrical cap member 28 attached to an upper surface of the case 27. A cap 29 having a specified standard size is constructed of the upper side of the case 27 and the cap member 28.

The case 27 is made of a synthetic resin having an insulation property and is formed into a cylindrical shape including an upper surface part 27a, an outer circumferential part 27b and an opened lower surface. An insertion hole 30 through which the optical component 22 is inserted is formed at the center of the upper surface part 27a of the case 27. An annular board support part 31 to support a circuit board of the lighting circuit 23 is formed on an inner circumferential part and an outer circumferential part of the upper surface part 27a of the case 27.

The cap member 28 is made of, for example, a metal material such as aluminum die-cast and is formed into a cylindrical shape having an upper surface part 28a, a circumferential surface part 28b, and an opened lower surface. The cap member 28 is attached to the case 27 by a plurality of screws screwed to the cap member 28 through the upper surface part 27a of the case 27. Incidentally, the cap member 28 is not limited to the metal material and may be formed of a material excellent in heat conductivity such as ceramic.

A protrusion 32 protruding downward from the upper surface part 28a of the cap member 28 is integrally formed on the upper surface part 28a of the cap member 28. A light-emitting module attachment part 28c as a semiconductor light-emitting element attachment part is formed on the front edge side of the protrusion 32. The light-emitting module 21 is thermally connected and is attached to an attachment surface as a lower surface of the light-emitting module attachment part 28c. A heat conductive sheet 33 is attached to an upper surface of the cap member 28. Besides, a plurality of keys 34 is protrudingly formed on the circumferential surface part of the cap member 28. Besides, not-shown cuts are provided in a peripheral edge part of the cap member 28 and at a plurality of asymmetrical positions in the circumferential direction.

The upper surface of the cap member 28 is constructed as a heat conductive part 28d which is thermally connected to the thermal radiator 17 of the lighting equipment 15 when the lamp device 14 is attached to the lighting equipment 15, and conducts and radiates heat generated by the light-emitting module 21 (semiconductor light-emitting element) to the external thermal radiator of the lighting equipment 15. Further, a portion extending from the light-emitting module attachment part 28c of the cap member 28 to the heat conductive part 28d is constructed as a heat conductive path 28e to conduct the heat generated by the light-emitting module 21 (semiconductor light-emitting element) to the thermal radiator 17 from the heat conductive part 28d. Besides, the upper surface part 27a of the case 27 intervenes between the cap member 28 including the heat conductive part 28d and the lighting circuit 23, and is constructed as a heat shielding unit 35 to shield heat between the lighting circuit 23 and the cap member 28 including the heat conductive part 28d.

The light-emitting module 21 includes a module board 37 as a board, a light-emitting part 38 formed on a lower surface of the module board 37, a frame-shaped holder 39 to hold the periphery of the module board 37, and a heat conductive sheet 40 intervening between the module board 37 and the light-emitting module attachment part 28c of the cap member 28 to which the module board 37 is attached.

The module board 37 is made of a material such as, for example, metal excellent in heat conductivity or ceramic and is formed into a flat plate shape.

In the light-emitting part 38, a semiconductor light-emitting element 38a such as, for example, an LED element or an EL element is used as a light source. In this embodiment, the LED element is used as the semiconductor light-emitting element 38a, and a COB (Chip On Board) system in which a plurality of LED elements is mounted on the module board 37 is adopted. That is, the plurality of LED elements is mounted on the module board 37, and the plurality of LED elements is electrically connected in series by wire bonding. The plurality of LED elements is integrally covered and sealed with a fluorescent layer of transparent resin such as, for example, silicone resin mixed with a fluorescent material. For example, an LED element emitting blue light is used as the LED element, and a fluorescent material which is excited by part of the blue light from the LED element and emits yellow light is mixed in the fluorescent layer. Accordingly, the LED elements and the fluorescent layer constitute the light-emitting part 38, the surface of the fluorescent layer as the surface of the light-emitting part 38 becomes a light-emitting surface, and illumination light is emitted from the light-emitting surface. Incidentally, a system may be used in which a plurality of SMD (Surface Mount Device) packages each mounted with an LED element and having a connection terminal are mounted on a board.

The holder 39 holds the module board 37, and is fixed by a plurality of screws 41 screwed to the light-emitting module attachment part 28c of the cap member 28 in a state where the heat conductive sheet 40 and the module board 37 are sandwiched between the holder and the light-emitting module attachment part 28c of the cap member 28. By the holder 39, the module board 37 is brought into close contact with the light-emitting module attachment part 28c of the cap member 28 through the heat conductive sheet 40, that is, is thermally connected, and excellent heat conductivity from the module board 37 to the cap member 28 is secured.

The optical component 22 is constructed of a cylindrical reflector 44. The reflector 44 is made of, for example, a synthetic resin having insulation property. A cylindrical light guide part 45 is formed whose upper and lower surfaces are opened and whose diameter expands stepwise or continuously from the upper end side to the lower end side. An annular cover part 46 to cover a lower surface periphery of the case 27 is formed at a lower end of the light guide part 45. A reflective surface having high light reflectivity, which is, for example, a white or mirror surface, is formed on an inner surface of the light guide part 45 and a lower surface of the cover part 46.

An upper side of the light guide part 45 passes through the circuit board of the lighting circuit 23 and the insertion hole 30 of the case 27, and is arranged around the light-emitting part 38 of the light-emitting module 21. A board press part 47 to hold the circuit board of the lighting circuit 23 between itself and the board support part 31 of the case 27 is formed on the outer circumferential surface of the light guide part 45 and at an intermediate part in the up-and-down direction.

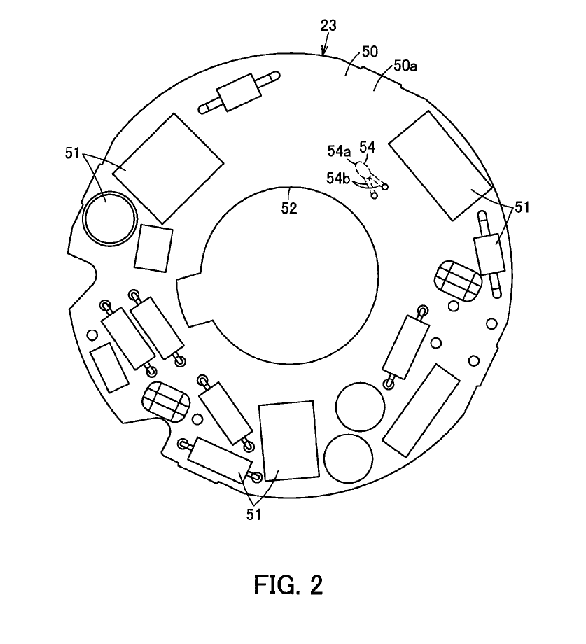

Besides, as shown in FIG. 1 and FIG. 2, the lighting circuit 23 includes a power supply circuit to rectify and smooth, for example, a commercial AC power supply into DC power supply, a DC/DC converter which converts the DC power supply into specified DC output by switching of a switching element and supplies it to the LED element to light the LED element, and a control IC to control the oscillation of the switching element. In the case of the dimming compatible lighting circuit 23, a function is provided in which the current of the LED element is detected and is compared with a reference value corresponding to a dimming signal, and the control IC controls the switching operation of the switching element.

The lighting circuit 23 includes a circuit board 50 as a board, and components 51 as a plurality of electronic components mounted on the circuit board 50.

The circuit board 50 is formed into an annular shape, a circular through hole 52 through which the upper side of the light guide part 45 of the reflector 44 passes is formed at the center of the circuit board 50. A lower surface of the circuit board 50 is a mount surface 50a on which among the components 51, a lead component including a lead wire is mounted. An upper surface thereof is a connection surface 50b as a wiring pattern surface or a solder surface to which the lead wire of the lead component is connected by solder and on which a wiring pattern for mounting a surface mount component among the components 51 is formed.

The circuit board 50 is arranged at an upper position in the case 27 in a state where the connection surface 50b is directed upward and faces the cap 29 or the light-emitting module 21. The components 51 mounted on the mount surface 50a of the circuit board 50 are arranged in a space among the outer circumferential part 27b of the case 27, the light guide part 45 of the reflector 44 and the cover part 46.

A pair of lamp pins 53 for power supply is electrically connected to the power supply input side of the circuit board 50, and the LED elements of the light-emitting module 21 are electrically connected to the lighting output side. The pair of lamp pins 53 is protruded vertically from the upper surface part 27a of the case 27. Incidentally, if the lamp device 14 is dimming compatible, a plurality of lamp pins for dimming is protruded vertically from the upper surface part 27a of the case 27 in addition to those for power supply.

A thermosensor 54 constructed of, for example, a thermistor is mounted on the circuit board 50. The thermosensor 54 includes a thermosensor body 54a and a pair of lead wires 54b connected to the thermosensor body 54a, and tips of the pair of lead wires 54b are electrically and mechanically connected to the circuit board 50.

The thermosensor body 54a is separated from the connection surface 50b of the circuit board 50 by the lead wire 54b, passes through a hole part 27c provided in the upper surface part 27a of the case 27, and is arranged inside the cap member 28. The thermosensor body is thermally connected to the light-emitting module attachment part 28c of the cap member 28 as the housing 20. In order to thermally connect the thermosensor body 54a to the cap member 28, for example, the thermosensor body 54a and the cap member 28 are bonded to each other by a heat conductive member 55 of silicone resin or the like and are thermally connected, or the thermosensor body 54a is brought into contact with the cap member 28, and the thermosensor body 54a can certainly detect the temperature of the cap member 28. Besides, even if a gap exists between the thermosensor body 54a and the cap member 28, radiant heat from the cap member 28 is irradiated to the thermosensor body 54a, and the thermosensor body 54a can detect the temperature of the cap member 28.

The thermosensor 54 detects the temperature in the heat conductive path 28e to conduct heat generated by the LED element from the heat conductive part 28d to the thermal radiator 17, or indirectly detects the temperature at a lamp life determination point TC which is previously set in the heat conductive part 28d and is for determining lamp life according to the temperature of the housing 20.

The lighting circuit 23 controls lighting of the LED element according to the temperature detected by the thermosensor 54, and monitors the temperature in the heat conductive path 28e or the temperature at the lamp life determination point TC based on the detection of the thermosensor 54. When abnormal thermal radiation is determined in which the detected temperature is a previously set temperature or higher, the lighting circuit controls to turn off the LED element, or dims and controls to reduce the output of the LED element in the case of the dimming compatible lamp device 14. The monitor of the temperature at the lamp life determination point TC by the lighting circuit 23 can be performed by estimating the temperature at the lamp life determination point TC previously determined by measurement or the like correspondingly to the temperature detected by the thermosensor 54.

In order to control to turn off the LED element, for example, when the control IC determines the abnormal thermal radiation, the oscillation of the switching element of the DC/DC converter is stopped. Besides, in order to dim and control the LED element, for example, when the control IC determines the abnormal thermal radiation, dimming is performed to decrease the output of the LED element based on a voltage value obtained by adding a specified dummy voltage to the actual detection voltage of the LED element. Alternatively, dimming is performed to decrease the output of the LED element by changing a threshold of reference value corresponding to a dimming signal with which the detection current of the LED element is compared.

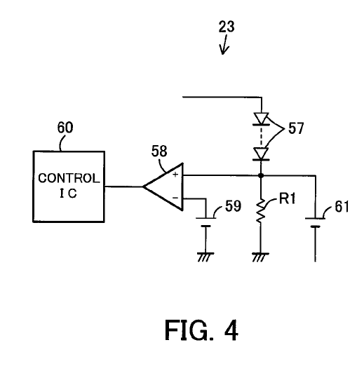

FIG. 4 shows an example of dimming and controlling LED elements 57 by the lighting circuit 23 at the time of detection of the abnormal thermal radiation of the lamp device 14. A resistor R1 of a voltage detection circuit is connected to the plurality of LED elements 57. The voltage of the LED element 57 is inputted to one input terminal of a comparator 58 from a connection point between the LED element 57 and the resistor R1, and a reference voltage corresponding to a dimming degree is inputted to the other input terminal of the comparator 58 from a reference voltage source 59. The comparison result of the comparator 58 is inputted to a control IC 60, and the control IC 60 controls the switching element of the DC/DC converter, and dims and controls the LED elements 57. The lighting circuit 23 is constructed such that when the abnormal thermal radiation is determined from the detected temperature of the thermosensor 54, a dummy voltage from a dummy voltage source 61 is applied to the connection point between the LED element 57 and the resistor R1. By this, since a voltage obtained by adding the voltage of the LED element 57 and the dummy voltage is inputted to the one input terminal of the comparator 58, the control IC 60 compares the added voltage with the reference voltage, and dims and controls to decrease the output of the LED elements 57.

Besides, the translucent cover 24 has translucency and diffusibility, and is made of, for example, synthetic resin or glass into a disk shape. The translucent cover 24 covers the lower surface opening of the case 27 and is attached to the case 27. In the attachment state, the cover part 46 of the reflector 44 is sandwiched and held between the translucent cover 24 and the case 27.

Next, as shown in FIG. 3, the lighting equipment 15 includes a reflector 16, a thermal radiator 17 and a socket 18, and includes a terminal stand 65 attached to the upper part of the thermal radiator 17 by an attachment plate 64, and a plurality of attachment springs 66 for ceiling attachment attached to the periphery of the thermal radiator 17.

A circular opening 68 in which the thermal radiator 17 is exposed is formed in the top of the reflector 16.

The thermal radiator 17 is formed of a material such as, for example, a metal such as aluminum die-cast, ceramic or resin excellent in heat dissipation. The thermal radiator 17 includes a columnar base part 69, and a plurality of thermal radiation fins 70 radially protruding from the periphery of the base part 69. A flat contact surface 71 exposed in the reflector 16 through the opening 68 of the reflector 16 is formed on the lower surface of the base part 69. The attachment springs 66 are attached to the periphery of the base part 69.

The socket 18 includes a socket body 73 made of a synthetic resin having an insulation property and formed into an annular shape, and a pair of not-shown terminals for power supply arranged on the socket body 73. In a dimming compatible case, a plurality of terminals for dimming is also provided.

A circular opening 74 through which the cap member 28 of the cap 29 of the lamp device 14 is inserted is formed at the center of the socket body 73. A plurality of connection holes 75 in which the lamp pins 53 of the lamp device 14 is inserted is formed into a long hole shape in the lower surface of the socket body 73 along the circumferential direction. Terminals are arranged at the upper sides of the respective connection holes 75, and the lamp pins 53 of the lamp device 14 inserted in the connection holes 75 are electrically connected.

A plurality of keys is protrudingly formed on the inner circumferential surface of the socket body 73, and a plurality of substantially L-shaped key grooves is formed therein. The key grooves of the socket 18 and the keys 34 of the lamp device 14 are respectively provided at corresponding positions. The cuts of the lamp device 14 are constructed to enable insertion at specified positions into the keys of the socket 18. That is, in the lamp device 14, positioning in the rotation direction is performed by the cuts of the lamp device 14 and the keys of the socket 18 and by the keys 34 of the lamp device 14 and the key grooves of the socket 18. The keys 34 and the cuts of the lamp device 14 are made to coincide with the key grooves and the keys of the socket 18, the cap 29 of the lamp device 14 is inserted into the socket 18, and the lamp device 14 is rotated, so that the lamp device 14 can be detachably mounted on the socket 18.

The socket 18 is supported to the thermal radiator 17 by a support mechanism 76. This support mechanism 76 is constructed such that when the cap 29 of the lamp device 14 is mounted on the socket 18, the heat conductive part 28d of the cap 29 is pressed to and brought into close contact with the contact surface 71 of the thermal radiator 17 and is thermally connected thereto.

Besides, the terminal stand 65 is electrically connected to the terminals of the socket 18.

In the luminaire 11 constructed of the lamp device 14 and the lighting equipment 15 as stated above, in order to mount the lamp device 14 on the lighting equipment 15, the cap 29 of the lamp device 14 is inserted in the socket 18 of the lighting equipment 15 and is rotated by a specified angle. As a result, the respective keys 34 of the cap 29 and the respective key grooves of the socket 18 are fitted in and caught by each other, and the lamp device 14 can be attached to the socket 18. By this, the respective lamp pins 53 of the cap 29 contact the respective terminals of the socket 18 and are electrically connected. Besides, the heat conductive part 28d of the cap 29 is pressed to and brought into close contact with the contact surface 71 of the thermal radiator 17, the heat conductive part 28d and the thermal radiator 17 are thermally connected to each other, and efficient heat conduction is enabled from the heat conductive part 28d to the thermal radiator 17.

At the time of lighting of the lamp device 14, the commercial AC power is fed to the lighting circuit 23 through the terminal stand 65, the terminals of the socket 18 and the lamp pins 53 of the lamp device 14. The lighting circuit 23 supplies the lighting power to the LED elements of the light-emitting module 21, and the LED elements are lit. The light emitted from the light-emitting part 38 by lighting of the LED elements travels in the light guide part 45 of the reflector 44, passes through the translucent cover 24, and is emitted from the lower opening of the lighting equipment 15.

At the time of lighting of the lamp device 14, heat generated by the LED elements of the light-emitting module 21 is conducted from the module board 37 to the light-emitting module attachment part 28c of the cap member 28, is conducted from the light-emitting module attachment part 28c to the heat conductive part 28d, and is conducted from the heat conductive part 28d to the thermal radiator 17. That is, the heat generated by the LED elements is conducted to the thermal radiator 17 through the heat conductive path 28e. The heat conducted to the thermal radiator 17 is radiated to the air from the surface of the thermal radiator 17 including the plurality of thermal radiation fins 70.

Besides, heat generated by the components 51 of the lighting circuit 23 is conducted to the outer circumferential part 27b of the case 27 and the translucent cover 24, and is radiated to the air from the surface of the outer circumferential part 27b of the case 27 and the translucent cover 24.

Besides, at the time of lighting of the lamp device 14, the lighting circuit 23 monitors the temperature detected by the thermosensor 54. That is, the lighting circuit 23 monitors the temperature in the heat conductive path 28e or the temperature at the lamp life determination point TC based on the detection of the thermosensor 54, and determines whether or not abnormal thermal radiation occurs in which the detected temperature is the previously set temperature or higher.

In the luminaire 11 constructed of the lamp device 14 and the lighting equipment 15 as stated above, when a plurality of kinds of lamp devices 14 is prepared according to, for example, difference in output of the light-emitting module 21, and a plurality of kinds of lighting equipments 15 suitable for the respective kinds of lamp devices 14 is provided according to difference in thermal radiation performance, the thermal radiation performance of the lighting equipment 15 is optimized according to the output of the lamp device 14, the suitable kinds of lamp devices 14 and lighting equipments 15 are combined and used.

At this time, even if the lamp device 14 having low output is mounted on the lighting equipment 15 suitable for the lamp device 14 having high output, the heat dissipation becomes merely excessive, and desired thermal radiation performance of the lamp device 14 can be achieved. On the other hand, if the lamp device 14 having high output is mounted on the lighting equipment 15 suitable for the lamp device 14 having low output, there is a fear that desired thermal radiation performance of the lamp device 14 cannot be achieved, and abnormal thermal radiation of the lamp device 14 occurs.

When the lamp device 14 is mounted on the suitable lighting equipment 15, or the lamp device 14 having low output is mounted on the lighting equipment 15 suitable for the lamp device 14 having high output, and the desired thermal radiation performance of the lamp device 14 is achieved, the temperature detected by the thermosensor 54 falls within a previously set normal range. Thus, the lighting circuit 23 determines to be normal and continues the lighting of the LED elements.

On the other hand, when the lamp device 14 having high output is mounted on the lighting equipment 15 suitable for the lamp device 14 having low output, and the desired thermal radiation performance of the lamp device 14 cannot be achieved, as compared with the case where the desired thermal radiation performance is achieved, the thermal conductivity of the heat generated by the LED elements to the thermal radiator 17 is reduced, the heat is stored in the cap member 28 and the temperature of the cap member 28 rises. By this, the temperature in the heat conductive path 28e or the temperature at the lamp life determination point TC rises, and the temperature detected by the thermosensor 54 exceeds the previously set normal range and falls within the range of abnormal thermal radiation. The lighting circuit 23 determines that the abnormal thermal radiation occurs, and suppresses the amount of heat generation of the LED elements by controlling to turn off the LED elements or by performing dimming control for reducing the output of the LED elements in the case of the dimming compatible lamp device 14.

When the detected temperature is returned to the normal range by suppressing the amount of heat generation of the LED elements, the turning-off control or the dimming control of the LED elements may remain continued or may be returned to the control at the normal time.

Besides, even when the lamp device 14 is mounted on the suitable lighting equipment 15, or the lamp device 14 having low output is mounted on the lighting equipment 15 suitable for the lamp device 14 having high output, if the desired thermal radiation performance of the lamp device 14 is not achieved because, for example, the heat conductive part 28d is not thermally connected to the thermal radiator 17 due to some defective attachment, as stated above, the lighting circuit 23 determines that the abnormal thermal radiation occurs, and suppresses the amount of heat generation of the LED elements.

Besides, the lighting circuit 23 monitors the temperature at the lamp life determination point TC based on the detection of the thermosensor 54, and makes a determination of lamp life in which the detected temperature is a previously set temperature or higher, and for example, the operation of the lighting circuit 23 is stopped and controlled. The monitor of the temperature at the lamp life determination point TC can be performed by estimating the temperature at the lamp life determination point TC previously set by measurement or the like correspondingly to the temperature detected by the thermosensor 54.

According to this embodiment, in the lamp device 14 in which the heat conductive part 28d of the housing 20 is thermally connected to the thermal radiator 17, and the heat generated by the LED elements is conducted to the thermal radiator 17, the state in which the heat generated by the LED elements is conducted to the thermal radiator 17 from the heat conductive part 28d is grasped by the detection of the thermosensor 54 thermally connected to the heat conductive part 28d, and the abnormal thermal radiation due to the defective heat conduction from the heat conductive part 28d to the thermal radiator 17 can be detected. Thus, the control of turning off or dimming the LED elements is performed according to the detection of the abnormal thermal radiation, so that the amount of heat generation of the lamp device 14 is suppressed, and the abnormal heat generation of the lamp device 14 can be prevented.

Besides, since the thermosensor 54 detects the temperature of the heat conductive path 28e for conducting the heat generated by the LED elements to the thermal radiator 17 from the heat conductive part 28d, the abnormal thermal radiation can be certainly detected.

Besides, since the thermosensor 54 detects the temperature at the lamp life determination point TC which is provided in the heat conductive part 28d and at which the lamp life is determined according to the temperature, the thermosensor 54 can be used for both the detection of abnormal thermal radiation and the detection of lamp life, and the structure of the lamp device 14 can be simplified.

Besides, since the heat shielding unit 35 shields the heat between the heat conductive part 28d and the lighting circuit 23, the heat generated by the components 51 of the lighting circuit 23 is suppressed from being conducted to the heat conductive part 28d. Thus, the erroneous detection of the thermosensor 54 due to the influence of the heat generated by the components 51 of the lighting circuit 23 can be prevented, and the abnormal thermal radiation can be accurately detected.

Incidentally, as the heat shielding unit 35 to shield the heat between the heat conductive part 28d and the lighting circuit 23, when the upper surface part 27a of the case 27 is used, the number of components can be reduced. However, a separate heat shielding member such as, for example, a heat shielding sheet may be used.

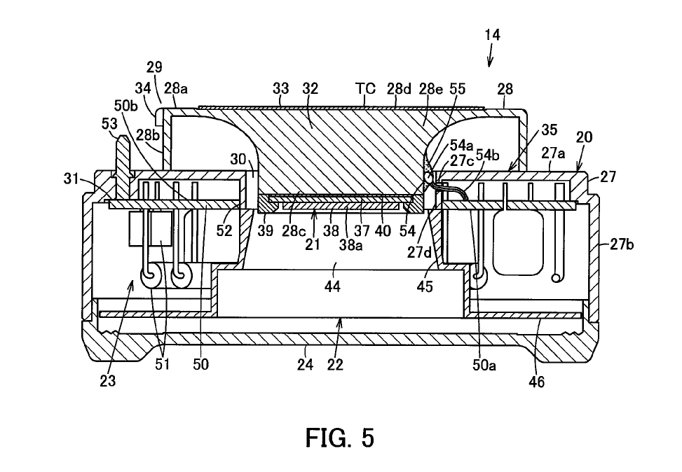

Next, a second embodiment will be described with reference to FIG. 5.

A protrusion 32 of a cap member 28 and a light-emitting module attachment part 28c are inserted in an insertion hole 30 of a case 27 such that the amount of protrusion from an upper surface part 28a is large so as to approach a translucent cover 24 side. Incidentally, the amount of protrusion from the upper surface part 28a may be made larger so that the protrusion 32 and the light-emitting module attachment part 28c pass through the insertion hole 30 of the case 27 and an insertion hole 52 of a circuit board 50 and so as to further approach the translucent cover 24.

When a light-emitting module 21 approaches the translucent cover 24 side by the largely protruding light-emitting module attachment part 28c as stated above, light extraction efficiency can be improved.

In this case, a heat conductive path 28a from the light-emitting module attachment part 28c to a heat conductive part 28d becomes long, and the heat conductive path 28a approaches a lighting circuit 23 and is liable to receive a heat influence from the lighting circuit 23. Accordingly, a heat shielding unit 35 is arranged between the heat conductive path 28e and the lighting circuit 23 and heat is shielded. Although the heat shielding unit 35 is constructed of an upper surface part 27a of the case 27 and an inner circumferential part 27d, a separate heat shielding member may be used.

A thermosensor body 54a of a thermosensor 54 is arranged between the inner circumferential surface 27d of the case 27 and a circumferential surface of the protrusion 32 through a hole part 27c formed in the inner circumferential surface 27d of the case 27, and directly contacts the circumferential surface of the protrusion 32. Further, the thermosensor body is bonded and held by a heat conductive member 55 and thermally contacts.

Also in this embodiment, the same operation and effect as those of the former embodiment can be obtained.

While certain embodiments have been described, these embodiments have been presented by way of example only, and are not intended to limit the scope of the inventions. Indeed, the novel embodiments described herein may be embodied in a variety of other forms; furthermore, various omissions, substitutions, and changes in the form of the embodiments described herein may be made without departing from the spirit of the inventions. The accompanying claims and their equivalents are intended to cover such forms or modifications as would fall within the scope and spirit of the inventions.

### REFERENCE SIGNS LIST

11 luminaire
14 lamp device
17 thermal radiator
20 housing
23 lighting circuit
28d heat conductive part
28e heat conductive path
35 heat shielding unit
37 module board as board
38a semiconductor light-emitting element
50 circuit board as board
54 thermosensor
TC lamp life determination point

1. A lamp device comprising:
a semiconductor light-emitting element;
a housing including a heat conductive part which is thermally connected to an external thermal radiator and conducts heat generated by the semiconductor light-emitting element to the thermal radiator;
a thermosensor thermally connected to the heat conductive part; and
a lighting circuit to control the semiconductor light-emitting element according to detection of the thermosensor.

2. The device according to claim 1, wherein the thermosensor detects temperature of a heat conductive path to conduct the heat generated by the semiconductor light-emitting element from the heat conductive part to the thermal radiator.

3. The device according to claim 1, wherein the thermosensor detects temperature at a lamp life determination point which is for determining a lamp life and is set in the heat conductive part.

4. The device according to claim 1, wherein the semiconductor light-emitting element and the lighting circuit are respectively mounted on separate boards.

5. The device according to claim 1, further comprising a heat shielding unit to shield heat between the heat conductive part and the lighting circuit.

6. A luminaire comprising:
a lamp device comprising:
a semiconductor light-emitting element;
a housing including a heat conductive part which is thermally connected to an external thermal radiator and conducts heat generated by the semiconductor light-emitting element to the thermal radiator
a thermosensor thermally connected to the heat conductive part; and
a lighting circuit to control the semiconductor light-emitting element according to detection of the thermosensor; and
a thermal radiator to which the heat conductive part of the lamp device is thermally connected.

7. The luminaire according to claim 6, wherein the thermo sensor detects temperature of a heat conductive path to conduct the heat generated by the semiconductor light-emitting element from the heat conductive part to the thermal radiator.

8. The luminaire according to claim 6, wherein the thermo sensor detects temperature at a lamp life determination point which is for determining a lamp life and is set in the heat conductive part.

9. The luminaire according to claim 6, wherein the semiconductor light-emitting element and the lighting circuit are respectively mounted on separate boards.

10. The luminaire according to claim 6, further comprising a heat shielding unit to shield heat between the heat conductive part and the lighting circuit.

11. The device according to claim 2, further comprising a heat shielding unit to shield heat between the heat conductive part and the lighting circuit.

12. The device according to claim 3, further comprising a heat shielding unit to shield heat between the heat conductive part and the lighting circuit.

13. The device according to claim 4, further comprising a heat shielding unit to shield heat between the heat conductive part and the lighting circuit.
